(19) United States
(12) Patent Application Publication
(10) Pub. No.: US 2011/0219975 A1
(43) Pub. Date: Sep. 15, 2011

(54) Method of Colour Setting in a Rotary Printing Press

(75) Inventor: Gordon Whitelaw, Bilgola (AU)

(73) Assignee: FISCHER & KRECKE GMBH, Bielefeld (DE)

(21) Appl. No.: 13/116,454

(22) Filed: May 26, 2011

Related U.S. Application Data
(63) Continuation-in-part of application No. PCT/EP2009/008148, filed on Nov. 16, 2009.

(30) Foreign Application Priority Data
Dec. 2, 2008 (EP) 08020919.0

(51) Int. Cl. B41F 33/00

(52) U.S. Cl. 101/483

(57) ABSTRACT

A method of colour setting in a rotary printing press, in which a composition of an ink is adjusted until colour specifications of a printed product, that is formed by a substrate with the ink printed thereon, match given target colour specifications, including the steps of measuring (S1) a volume carrying capacity of an inking roller that will be used in the printing press for printing with the ink, measuring (S2) a spectral opacity of the substrate, measuring (S3) a spectral absorptivity of the ink when it is in a liquid state in the printing press; and entering the measured volume carrying capacity, spectral opacity and spectral absorptivity into a mathematical model (S4) for predicting the colour specifications of the printed product.

### BACKGROUND OF THE INVENTION

The invention relates to a method of colour setting in a rotary printing press, wherein a composition of an ink is adjusted until colour specifications of a printed product, that is formed by a substrate with said ink printed thereon, match given target colour specifications.

More particularly, the invention relates to a method of colour setting in a flexographic printing press.

EP 1 916 102 A1 discloses a printing method wherein the dimensions and shapes of printing cylinders and anilox rollers of a flexographic printing press are measured before these cylinders and rollers are mounted in the press. Then, when a print run is to start and the cylinders and rollers have been mounted, the measured data are used for automatically adjusting the settings of these cylinders and rollers so as to readily achieve the desired spatial relations and compression forces for printing a high quality printed product from the outset, without any substantial production of waste.

However, colour setting still remains an intricate problem which has to be solved by try and error. For example, the visual colour impression of the printed product is inspected, and the composition of the ink or inks that are being used for printing are adjusted until the resulting colour impression matches the desired result. According to another known method, the colour specifications of the printed product are measured with a colour spectrometer or the like, and the measured specifications are then compared to the target specifications. The deviation of the colour specification of the printed product from the target specifications may be quantified by a certain parameter which is called ΔE, and when ΔE is not larger than a certain limit value, typically in the order of magnitude of 1 or 2, the colour composition is judged to be acceptable. If ΔE is larger, the colour composition of the ink has to be readjusted. This has to be done for each of the inks that are employed in the print process.

### SUMMARY OF THE INVENTION

It is an object of the invention to provide a more efficient method of colour setting.

In order to achieve this object, the method according to the invention is characterised by the steps of:
measuring a volume carrying capacity of an inking roller that will be used in the printing press for printing with said ink,
measuring a spectral opacity of the substrate,
measuring a spectral absorptivity of the ink when it is in a liquid state in the printing press, and
entering the measured volume carrying capacity, spectral opacity and spectral absorptivity into a mathematical model for predicting the colour specifications of the printed product.

This method is based on the finding that the colour specifications of the printed product can be predicted with sufficient accuracy, without actually printing the ink onto the substrate, when certain factors which influence the colour specifications of the printed product are determined in advance. The most decisive of these factors are the thickness of the ink layer that will be formed on the substrate in the print process, the spectral opacity of the substrate, and the spectral absorptivity of the liquid ink.

The thickness of the ink layer depends on the volume carrying capacity of the inking roller, i.e. the volume of ink that will be accumulated on the surface of the inking roller and the quantity that will then be transferred via the printing cylinder onto the substrate. For example, in a flexographic printing press, the inking roller is an anilox roller the surface of which has a fine pattern of cells in which the liquid ink is accommodated. Then, the volume carrying capacity of the anilox roller will depend upon the volume of the individual cells, the number of cells per surface area of the anilox roller, and the material of the anilox roller which determines the adsorptivity in relation to the ink. Since the properties of the anilox roller, especially the volume of the cells, is subject to manufacturing tolerances, the volume carrying capacity of an anilox roller varies from roller to roller. Thus, the volume carrying capacity is measured for each specific inking roller that is to be employed in the print process.

In a surface printing process where the ink layer is formed on the visible side of the substrate, the spectral opacity of the substrate indicates the amounts of light of several colours that are absorbed by the substrate when light in these colours, e.g. red, blue and green, is reflected at the substrate. Depending on the thickness of the printed ink layer, a smaller or larger part of the reflected light will be transmitted through the ink layer, so that it contributes to the visual colour impression of the printed product. In a reverse printing process, where the ink layer is formed on a back side of an essentially transparent substrate, the spectral opacity is given by the amounts of light in the different colours that are absorbed when (white) light passes through the substrate, is reflected at the ink layer given the background of the particular colour (for example white) and again passes through the substrate before it reaches the eye of the viewer.

The spectral absorptivity of the ink is given by the amounts of light in different colours that are absorbed by the ink when (white) light is transmitted therethrough. When the thickness of the ink layer on the substrate is known, this spectral absorptivity can be measured when the ink is still in the liquid state. However, the spectral absorptivity of the ink is not only subject to manufacturing tolerances but is also influenced by the specific condition of the liquid ink in the printing press, for example, the amount to which the ink is diluted with solvent and also the amount of air that is contained in the liquid ink when the ink is supplied to an ink fountain for being applied to the inking roller. This is why, according to the invention, the spectral absorptivity of the ink is measured when the ink in the liquid state in the printing press.

When all these quantities have been measured, they may be entered into a mathematical model that describes the thickness of the ink layer on the substrate and the way how the substrate and the ink layer change the spectral composition of (white) ambient light that is reflected at the printed product and reaches the eye of the viewer. In this way, it is possible to predict the colour specifications of the printed product even before such a printed product is actually obtained, and if it is found that the ΔE, based on the predicted colour specifications, is too large, it is possible to re-adjust the composition of the ink before an actual print process has been started.

Once the colour specifications of the printed product have been predicted, manufacturers of inks are capable of using or providing known algorithms which describe how the ink composition has to be modified in order to reduce the ΔE.

More specific features of the invention are indicated in the depended claims.

### BRIEF DESCRIPTION OF THE DRAWINGS

An embodiment example will now be described in conjunction with the drawing wherein:

FIG. 1 is a flow diagram of the method according to the invention;

FIG. 2 is a schematic view of a device that may be used for measuring a volume carrying capacity of an anilox roller;

FIG. 3 is an enlarged cross-sectional view of a surface portion of the anilox roller;

FIG. 4 is a schematic view of an inking system of a printing press, including means for measuring the spectral absorptivity of the ink;

FIG. 5 is a schematic view of a device for measuring the opacity of a substrate for reverse printing; and

FIG. 6 is a schematic view of a device for measuring the opacity of the substrate for surface printing.

### DETAILED DESCRIPTION

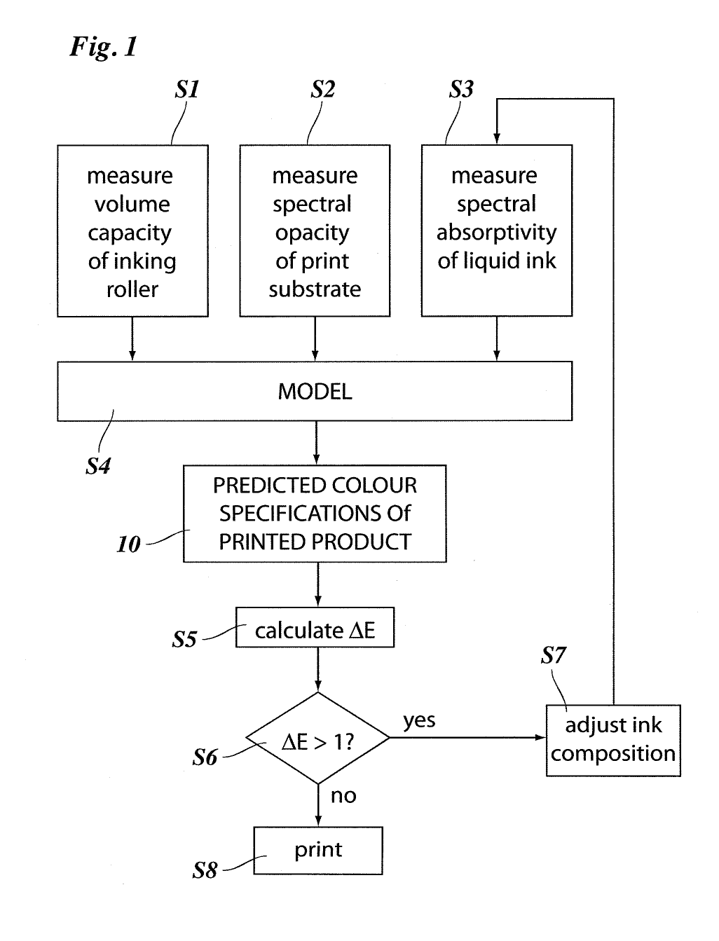

FIG. 1 is a flow diagram illustrating the basic steps of the method according to the invention. Steps S1-S3 are performed when a printing press is prepared for a print run. The time sequence, in which these steps are performed is not essential.

Step S1 consists of measuring the volume carrying capacity of an inking roller that shall be used in a specific colour deck of the printing press. Preferably, this step is performed before the inking roller is mounted in the press.

Step S2 is a step of measuring the spectral opacity of the print substrate. This step may be performed at any time prior to the print process by inspecting a suitable sample of the print substrate in the printing press or outside the press. The term “spectral opacity” indicates a set of at least three values that describe the opacity of the print substrate, either in reflectance or in transmission, for at lest three basic colours that span the entire colour space, e.g. the colours RGB or CMY.

The step S3 is a step of measuring the spectral absorptivity of the liquid ink. Here the term “spectral” has the same meaning as in the definition of spectral opacity.

In step S4, the data that have been measured in steps S1-S3 are entered into a mathematical model, typically a software program that is run on a computer and delivers as output a prediction 10 for the colour specifications of the printed product. For the purposes of this invention, the “printed product” can be thought of as a piece of substrate (of which the spectral opacity has been measured in step S2) with a solid single-colour area printed thereon, i.e. the substrate bears a uniform layer of the ink of which the spectral absorptivity has been measured in step S3.

Based on the volume carrying capacity of the inking roller that has been measured in step S1, the model predicts the thickness T of the ink layer on the substrate. Assuming that no ink gets lost in the print process in those image areas where ink is actually deposited on the substrate, the thickness of a layer of liquid ink on the substrate would be given by the measured volume carrying capacity divided by the total surface area of the inking roller. In practice, of course, the thickness of the ink layer on the substrate will shrink because solvent evaporates from the ink. However, if the effect of the solvent on the spectral absorptivity of the ink can be neglected, the “optical thickness” of the layer of dried ink will be equal to the thickness of the hypothetical layer of liquid ink. If there should be an influence of the solvent on the absorptivity, this influence can be included in the model using, for example, the detected viscosity of the liquid ink as a measure for the solvent content.

The model in step S4 further describes the light reflection, transmission and absorption processes at or in the ink layer on the substrate and at or in the substrate, depending upon whether the print process is a surface printing process or a reverse printing process. These reflection, transmission and absorption processes are calculated for the three basic colours which have been used for defining the spectral opacity of the substrate and the spectral absorptivity of the ink. Thus, the prediction 10 output by the model will comprise at least three values that describe the expected colour impression of the printed product.

In many practical applications, the ink layer thickness T, the spectral opacity of the print substrate, and the spectral absorptivity of the ink as measured in steps S1 to S3 can be described as relatively small deviations from corresponding standard values, so that a linear model may be employed in step S4. For example, using an LHC colour space (luminance L, hue H and chrominance C), the output of the model will be formed by the L, H, and C values of the expected colour impression, and the model may describe the dependency of this output from five input values P, S, T, B and W which have the following meanings:

P pigment hue of the ink
S concentration of the ink
T thickness of ink layer
B background hue
W background lightness,
P and S represent the spectral absorptivity of the ink as measured in step S3, and B and W represent the spectral opacity of the substrate.

If P₀, S₀, T₀, B₀, and W₀ are the standard values of the input, resulting in a colour impression with standard LHC values L₀, H₀, and C₀, and ΔP, ΔS, ΔT, ΔB, ΔW, ΔL, ΔH, ΔC are the respective deviations, so that: P=P₀+ΔP, S=S₀+ΔS, T=T₀+ΔT, B=B₀+ΔB, W=W₀+ΔW, L=L₀+ΔP, H=H₀+ΔH, and C=C₀+ΔC, then the input may be described by a vector ΔI with the five components (ΔP, ΔS, ΔT, ΔB, ΔW), the output may be described by a vector ΔO with the three components (ΔL, ΔH, ΔC), and the linear model is given by the equation:

ΔO=M*ΔI

wherein M is a constant 5×3 matrix the coefficients of which can be determined by experiment or derived by theoretical considerations. For example, when M is determined experimentally, actual values of P, S, T, B and W, which will roughly give the desired colour impression, are measured and are taken as standard values P₀, S₀, T₀, B₀, and W₀. A test print is made and the resulting colour values are measured and taken as L₀, H₀, and C₀. Then P is varied by a certain deviation ΔP and the resulting colour change ΔL, ΔH, ΔC is measured. As is well known in the art, three coefficients M_{1,1}, M_{2,1}, and M_{3,1} of the matrix M are obtained as: M_{1,1}=ΔL/ΔP, M_{2,1}=ΔH/ΔP, and M_{3,1}=ΔC/ΔP. Repeating this procedure with variations of S, T, B and W, respectively, provides the remaining 12 coefficients of the matrix M. Then, whenever a print run is performed with values of P, S, T, B and W which are not too far away from the standard values, the matrix M can be used to predict the values L, H, and C that specify the resulting colour impression.

Of course, a more elaborated non-linear model may also be used in step S4 for improved accuracy.

Then, in step S5, the predicted colour impression is compared to certain target specifications that are defined for example by known colour standards such as Pantone or the like. As is well known in the art, the deviation between the expected colour specifications and the target specifications can be quantified by a number ΔE which is calculated in step S5.

Then, it is decided in step S6 whether or not ΔE is larger than 1 (or any other suitable target value). If the answer is yes, this means that the visual colour impression of the printed product must be expected to unacceptably deviate from the target specifications, and the ink composition is adjusted in step S7. On the other hand, if step S6 shows that the expected colour specifications of the printed product are acceptable, the print process will be started in step S8.

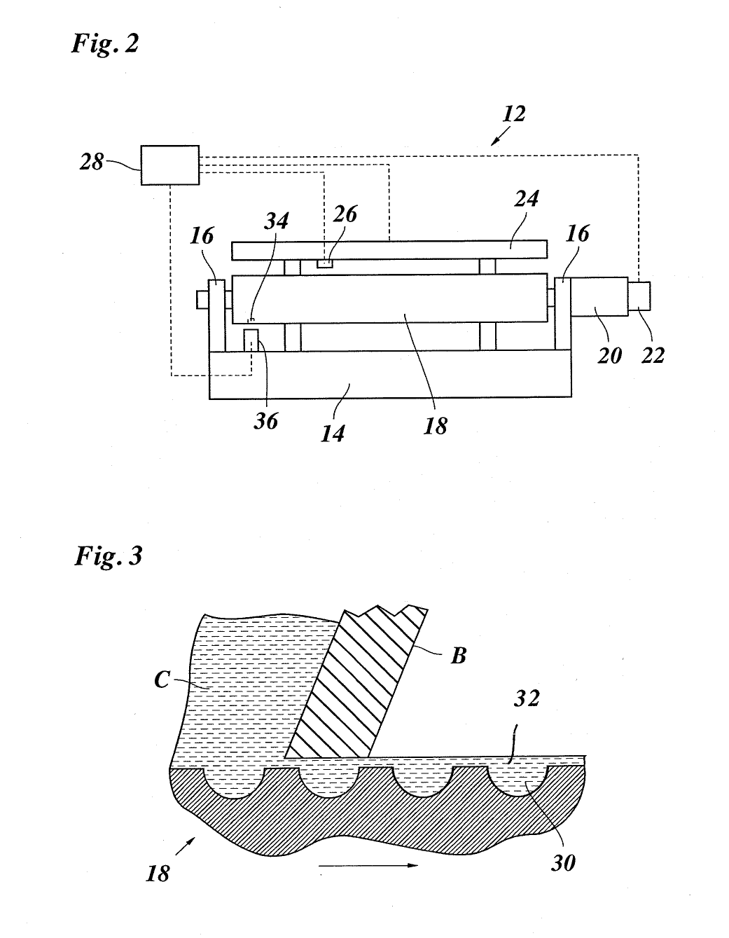

FIG. 2 shows a schematic front view of a so-called mounter 12, i.e. a rack that is normally used for preparing a printing cylinder before the same is mounted in the printing press, but may also be used for performing the step S1 in FIG. 1.

The mounter 12 has a base 14 and two releasable bearings 16 in which the opposite ends of an inking roller 18, e.g. an anilox roller for a flexographic printing press, are rotatably supported. A drive motor 20 is arranged to be coupled to the inking roller 18 to rotate the same, and an encoder 22 is coupled to the drive motor 20 for detecting the angular position of the inking roller 18.

The mounter 12 further comprises a rail 24 that is fixedly mounted on the base 14 and extends along the outer surface of the inking roller 18. An optical measuring head 26 is guided on the rail 24 and may be driven to move back and forth along the rail 24 so as to scan the surface of the inking roller 18. The rail 24 further includes a linear encoder which detects the position of the optical measuring head 26 and signals the same to a control unit 28. When the inking roller 18 is rotated, the encoder 22 counts the angular increments and signals them to the control unit 28, so that the control unit 28 can always determine the angular and axial coordinates of the optical measuring head 26 relative to the inking roller.

The optical measuring head 26 uses triangulation and/or interferometric techniques for measuring the height of the surface point of the inking roller 18 that is located directly underneath the current position of the optical measuring head. Thus, by rotating the inking roller 18 and moving the optical measuring head 26 along the rail 24, it is possible to scan the entire peripheral surface of the inking roller 18 and to capture a height profile or topography of that surface with an accuracy that may be as high as 1-2 μm, for example. To this end, the mounter may be calibrated to map inherent deviations of the rail 24, which will then be combined in the control unit 28 with the readings from the optical measuring head 26 so as to establish a more accurate topography.

In this way, the exact geometrical shape of the inking roller 18 can be determined with high accuracy in the control unit 28. In particular, it is possible to determine the exact surface area of the inking roller 18.

As is shown in FIG. 3, the surface of the inking roller 18 is formed with a fine raster of cells 30 that will be filled with ink 32 when, in the printing press, the inking roller passes a doctor blade B. Typically, the doctor blade will leave ink not only in the cells 30 but also in a thin layer on the surface of the inking roller. The thickness of this layer will depend upon the arrangement and the properties of the doctor blade and also upon the surface properties of the inking roller 18 and the properties of the ink and can thus be determined when these properties are known. Since the optical measuring head 26 scans the surface of the inking roller, it is possible to detect the geometry of the cells 30 and to determine the volume of the cells. Thus it is possible to determine the total volume of ink 32 that is carried on the inking roller. When the ink is transferred onto the printing cylinder of the press, a certain fraction of this volume will remain on the inking roller. This fraction, which is again determined by the known surface properties of the inking roller and the printing cylinder and the properties of the ink has to be detracted in order to determine the effective volume carrying capacity of the inking roller. Preferably, the effects of the various properties (material of the inking roller, ink type and condition, etc.) that influence the volume carrying capacity are assessed in advance in a calibration measurement, so that, for a given inking roller, and provided that the ink condition is kept stable, the volume carrying capacity can be calculated as a function of the measured cell volume.

When the inking roller 18 is operating in the printing press, the ink will be transferred onto the printing parts of the printing cylinder and, finally, onto the surface of the substrate. Thus, when the volume carrying capacity of the inking roller 18 and hence the volume of ink per unit area is known, it is also possible to determine the thickness of a layer that this liquid ink would form on the surface of the print substrate.

In the example shown in FIG. 2, the inking roller 18 includes a memory chip 34, e.g. a RFID chip, and the mounter 12 includes a write head 36 that is controlled by the control unit 28 and may be used for storing the relevant data on the surface area and the volume carrying capacity of the inking roller, so that these data are available in the printing press when the inking roller is mounted therein.

Another possible method for measuring the cell volume of the inking roller 18 may comprise the inspection of the surface of the inking roller with a stereographic video camera system and calculating the dimensions and volumes of the cells 30 from the video data. Yet another method may comprise the steps of applying a metered amount of liquid ink onto the surface of the inking roller 18, spreading that ink on the surface until it has filled all cells 30 in a certain coherent region on the surface of the inking roller, and then measuring the surface area of that region.

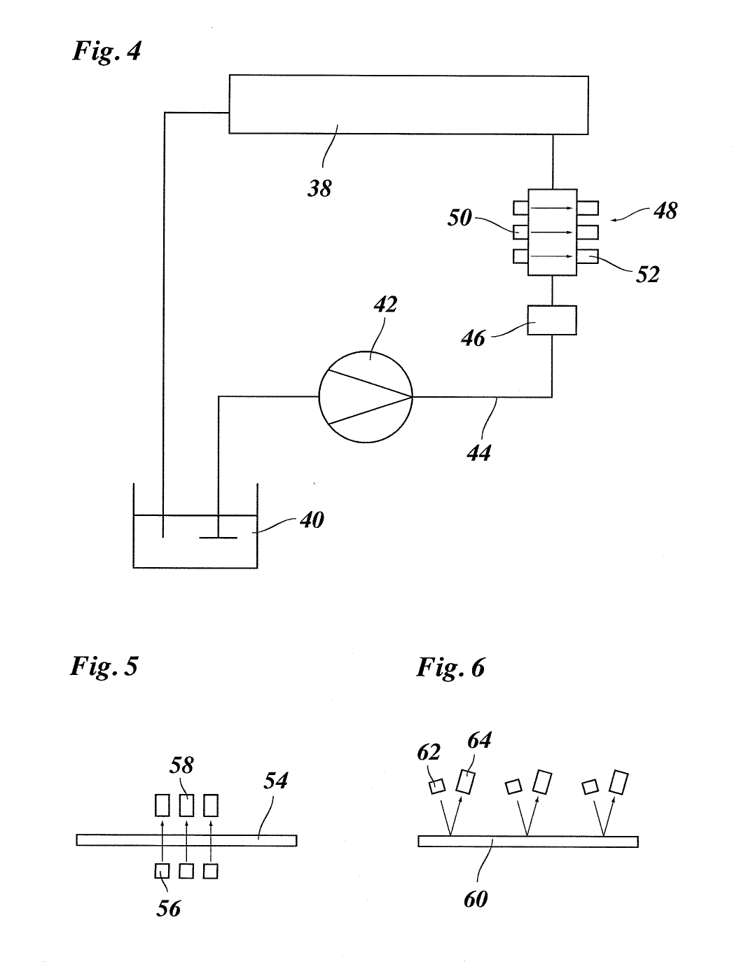

FIG. 4 shows the essential components of an inking system of a flexographic printing press, for example. This inking system comprises an ink fountain 38 that is arranged at the peripheral surface of the inking roller 18 when the latter is mounted in the printing press and serves for filling the cells 30 with liquid ink. The inking system further comprises an ink reservoir 40 and a pump 42 for pumping liquid ink from the ink reservoir 40 to the ink fountain 38. Excessive ink that is not transferred to the surface of the ink roller 18 will be returned from the ink fountain 38 to the ink reservoir 40.

An ink line 44 which connects the pump 42 to the ink fountain 38 includes a viscosimeter 46 for detecting the viscosity of the liquid ink. As is known in the art, the viscosity of the ink must be maintained in a certain range, and when the viscosity is about to leave that range, the viscosity will be adjusted by adding either solvent or ink concentrate. Although not shown in FIG. 4, the inking system may also include a temperature regulating system for regulating the temperature of the ink in the ink fountain 38. Further, PH control and measurement with the addition of water amide for water based inks may be included.

The ink line 44 further includes a measuring chamber 48 for measuring the spectral absorptivity of the ink that passes through this chamber. Three standardized light sources 50 in the basic colours of a suitable colour space, e.g. RGB, are mounted on one side of the measuring chamber 48, and corresponding light detectors 52 are mounted on the opposite side of the measuring chamber, so that, for each of the basic colours, the light intensity that has been transmitted through the liquid ink in the chamber 48 can be detected. Since the amount of light emitted by the light sources 50 is known, it is possible to calculate the absorptivities of the ink for the respective basic colours. Thus, this inking system is suitable for performing the step S3 in FIG. 1.

Since the spectral absorptivity of the liquid ink in the measuring chamber 48 may be influenced by the solvent content of the ink and, in particular, by an amount of air that is included in the liquid ink, it is preferable that the measurement of the spectral absorptivity is started only after the ink has been pumped through the inking system by means of the pump 42 for a certain time, until the physical and chemical condition of the ink (thixotropy) has reached a stable state that will then be maintained throughout the print process. This assures that the spectral absorptivity that is measured before the print process begins will reflect the actual properties of the ink during the print process.

FIGS. 5 and 6 illustrate different embodiments of the step S2 in FIG. 1, suitable for a reverse printing process and a surface printing process, respectively.

FIG. 5 shows a transparent print substrate 54, three standardized light sources 56 that are similar to the light sources 50 in FIG. 4 and are disposed on one side of the substrate 54, and three light detectors 58 similar to the light detectors 52 in FIG. 4 and disposed on the other side of the substrate 54 opposite to the light sources 56. This arrangement is suitable for measuring the spectral opacity of the substrate 54 in transmission.

FIG. 6 shows a substrate 60 and three pairs of light sources 62 and light detectors 64 arranged on the same side of the substrate 60 for measuring the spectral opacity of the substrate in reflection.

Although only three pairs of light sources and light detectors for three basic colours have been shown in FIGS. 4 to 6, it is clear that a larger number of light sources and detectors for a corresponding larger number of basic colours can be used.

Ideally, a photospectrometer would be used for detecting the entire absorption spectrum of the substrate and the ink, respectively, over the entire wavelength range of visible light. However, for practical purposes, it will generally be sufficient to measure the absorption only at three or more specific wave lengths for giving a sufficiently exact description of the spectral opacities and absorptivities. The measurement results obtained with the detectors 52, 58 and 64 may be calibrated on the basis of more precise measurements performed with photo-spectrometers. When the calibrated measurement results are entered into the model in step S4 in FIG. 1, they will yield a sufficiently accurate prediction of the colour specifications of the printed product in a suitable colour space such as the LAB space, which prediction may then be compared to the pertinent colour standards.

1. A method of colour setting in a rotary printing press, wherein a composition of an ink is adjusted until colour specifications of a printed product, that is formed by a substrate with said ink printed thereon, match given target colour specifications, comprising by the steps of:
measuring a volume carrying capacity of an inking roller that will be used in the printing press for printing with said ink,
measuring a spectral opacity of the substrate,
measuring a spectral absorptivity of the ink when it is in a liquid state in the printing press, and
entering the measured volume carrying capacity, spectral opacity and spectral absorptivity into a mathematical model for predicting the colour specifications of the printed product.

2. The method according to claim 1, wherein the step of measuring the volume carrying capacity includes the step of measuring the volume carrying capacity of the inking roller in a mounting rack before the inking roller is mounted in the printing press.

3. The method according to claim 1, wherein the inking roller is formed with a fine raster of cells in its peripheral surface, and the step of measuring the volume carrying capacity includes the step of optically detecting dimensions of the cells and calculating the volume thereof.

4. The method according to claim 1, wherein the step of measuring the spectral absorptivity of liquid ink is performed within an inking system of the printing press at the time when the ink has been pumped through the inking system for a time sufficient to reach a stable state of the ink.

5. The method according to claim 1, wherein the step of measuring the spectral opacity of the substrate includes a step of detecting light from standardized light sources that has been transmitted through the substrate, and the model is a model for reverse printing.

6. The method according to claim 1, wherein the step of measuring the spectral opacity of the substrate includes a step of detecting light from standardized light sources that has been reflected at the substrate, and the mathematical model is a model for surface printing.

7. The method according to claim 1, wherein the step of measuring the spectral opacity of the print substrate is performed for at least three basic colours, and the step of measuring the spectral absorptivity of the liquid ink is performed for the same basic colours.
